(19) United States
(12) Patent Application Publication
(10) Pub. No.: US 2013/0271520 A1
(43) Pub. Date: Oct. 17, 2013

(54) PRINTING APPARATUS AND PRINTING METHOD

(71) Applicant: Seiko Epson Corporation, Tokyo (JP)

(72) Inventor: Toshiaki Kakutani, Shiojiri-shi (JP)

(21) Appl. No.: 13/915,557

(22) Filed: Jun. 11, 2013

Related U.S. Application Data
(63) Continuation of application No. 12/548,380, filed on Aug. 26, 2009.

(30) Foreign Application Priority Data
Aug. 27, 2008 (JP) 2008-218393

(51) Int. Cl. B41J 2/21

(52) U.S. Cl. CPC B41J 2/2103
USPC 347/12

(57) ABSTRACT

A printing apparatus that prints an image on a print medium using special glossy ink and color ink, the printing apparatus includes a print head including a plurality of special glossy ink nozzles for ejecting the special glossy ink and a plurality of color ink nozzles for ejecting the color ink, a print unit that drives the print head, an obtaining part that obtains image data, a print controller that prints the obtained image data on the print medium by controlling the print head and the print unit. In a case of printing the obtained image data on the special glossy region, the print controller allows a group of the special glossy ink nozzles to be offset from a group of the color ink nozzles in the sub-scanning direction by a predetermined interval, and then performs the printing by ejecting the special glossy ink and the color ink at timings different from each other. In a case of printing the obtained image data on the dedicated color region, the print controller uses a relatively large number of the color ink nozzles as compared with a number of the color ink nozzles used when the special glossy region is printed.

This application is a continuation of U.S. patent application Ser. No. 12/548,380, filed Aug. 26, 2009, which claims the priority to Japanese Patent Application No. 2008-218393, filed Aug. 27, 2008, the entire disclosures of which are incorporated by reference herein.

### BACKGROUND OF THE INVENTION

1. Technical Field

The present invention relates to a method of printing an image on a print medium by using special glossy ink and color ink.

2. Related Art

According to the related art, in the field of electrophotography, a method has been proposed to form a β layer using a metallic toner on a metallic color region, and form a highly fine or rough process color toner layer on the p layer (see JP-A-2006-50347). According to this technology, the printing operation is performed in a state in which the metallic toner overlaps the process color toner, so metallic colors having various hues are produced.

A color printing technology using a toner includes a tandem scheme, a 4-cycle scheme and the like. These schemes perform a printing operation in a state in which toners of each color overlaps each other. In this regard, the above technology of performing the printing operation in the state in which the metallic toner overlaps the process color toner can be easily realized.

However, in the field of an inkjet printer, inks of each color are simultaneously ejected from a head on a print medium so that printing is performed. Thus, if special glossy ink such as metallic ink and normal color ink are simultaneously ejected, the special glossy ink is mixed with the color ink on the print medium, so the intended glossy effect or color formation may not be achieved. In order to prevent such a problem, an inkjet printing process may be divided into a process of printing the special glossy ink and a process of printing the color ink, and then the printing may be performed in a state in which the two processes overlap each other. However, the printing speed may be reduced, the number of process steps may be increased, and position offset may occur between the first printing and the secondary printing.

### BRIEF SUMMARY OF THE INVENTION

An advantage of some aspects of the invention is to improve the color formation when printing is performed using special glossy ink such as metallic ink and normal color ink in a printing scheme of printing an image by ejecting inks.

One embodiment of the invention is directed to a printing apparatus that prints an image on a print medium using special glossy ink and color ink, the printing apparatus comprising: a print head including a special glossy ink nozzle array having a plurality of special glossy ink nozzles for ejecting the special glossy ink and a color ink nozzle array having a plurality of color ink nozzles for ejecting the color ink, the special glossy ink nozzle array and the color ink nozzle array being disposed in a sub-scanning direction while facing each other; a print unit that drives the print head in a main scanning direction crossing the sub-scanning direction and carries the print medium relative to the print head in the sub-scanning direction; an image obtaining module that obtains image data having a dedicated color region, which is printed with the color ink, a special glossy region which is printed with the color ink and the special glossy ink; and a print controller that prints the obtained image data on the print medium by controlling the print head and the print unit, wherein, in a case of printing the obtained image data on the special glossy region, the print controller allows a group of the special glossy ink nozzles to be offset from a group of the color ink nozzles in the sub-scanning direction by a predetermined interval.

In one aspect, the print controller performs the printing by controlling the plurality of special glossy ink nozzles and the plurality of color ink nozzles to eject the special glossy ink and the color ink at timings different from each other.

In another aspect, in a case of printing the obtained image data on the dedicated color region, the print controller uses a relatively larger number of the plurality of color ink nozzles in comparison with a number of the plurality of color ink nozzles used when the special glossy region is printed.

In another aspect, the print controller controls the print head and the print unit to fill a local region of the dedicated color region with the color ink through a relatively large number of main scannings as compared with a number of main scannings of the print head, by which a local region of the special glossy region is filled with the color ink.

In another aspect, the print controller controls the print head and the print unit to fill a local region of the dedicated color region with the color ink through a relatively large number of main scannings as compared with a number of main scannings of the print head, by which a local region of the special glossy region is filled with the special glossy ink.

In another aspect, the print controller controls the print head and the print unit to fill a local region of the special glossy region with the special glossy ink through a relatively small number of main scannings as compared with a number of main scannings of the print head, by which the local region of the special glossy region is filled with the color ink. Thus, the printing apparatus can increase dot density, which can be formed by the color ink, in the special glossy region, as compared with dot density, which can be formed by the special glossy ink.

In another aspect, when the special glossy region is printed, the print controller sets a number of the plurality of special glossy ink nozzles, which are substantially used in the special glossy ink nozzle array, differently from a number of the plurality of color ink nozzles which are substantially used in the color ink nozzle array. Thus, the printing apparatus can set the number of the special glossy ink nozzles differently from the number of the color ink nozzles according to importance of the special glossy ink and the color ink.

In another aspect, when the special glossy region is printed, the print controller sets the number of the plurality of special glossy ink nozzles, which are substantially used in the special glossy ink nozzle array, to be smaller than the number of the plurality of color ink nozzles which are substantially used in the color ink nozzle array. Thus, the printing apparatus can increase dot density, which can be formed by the color ink, in the special glossy region, as compared with dot density, which can be formed by the special glossy ink.

In another aspect, the print controller controls the print head to eject special glossy ink droplets, which have a size larger than a size of color ink droplets ejected on the dedicated color region, on the special glossy region. Thus, the printing apparatus can increase the amount of the special glossy ink which is printed on a unit area with respect to the special glossy region in which the number of nozzles used per one color is smaller than the number of nozzles used when the dedicated color region is printed.

In another aspect, the print controller controls the print head to eject special glossy ink droplets and color ink droplets, which have a size larger than a size of color ink droplets ejected on the dedicated color region, on the special glossy region. Thus, the printing apparatus can increase the amount of the special glossy ink and the color ink which are printed on a unit area with respect to the special glossy region in which the number of nozzles used per one color or more is smaller than the number of nozzles used when the dedicated color region is printed.

In another aspect, the print controller controls the print head to eject color ink droplets, which have a size larger than a size of color ink droplets ejected on the dedicated color region, on the special glossy region. Thus, the printing apparatus can increase the amount of the color ink which is printed on a unit area with respect to the special glossy region in which the number of nozzles used per one color is smaller than the number of nozzles used when the dedicated color region is printed.

In another aspect, the print controller performs halftone processing relative to the special glossy region and the dedicated color region by using dither masks, which are different from each other, based on the characteristics of the special glossy region and the dedicated color region. Thus, the printing apparatus can perform printing by using the dither masks suitable for the special glossy region and the dedicated color region, respectively.

In another aspect, the print controller performs halftone processing relative to a first part of the special glossy region, which is printed with the color ink, and a second part of the special glossy region, which is printed with the special glossy ink, by using the dither masks having threshold value arrangements, which are different from each other. Thus, the printing apparatus can perform printing with respect to the first part, which is printed with the color ink, and the second part, which is printed with the special glossy ink, by using the dither masks suitable for the first and second parts, respectively.

In another aspect, the threshold values of the dither mask, which is used for the first part printed with the color ink of the special glossy region, are arranged in a plurality of first exclusive positions, and the threshold values of the dither mask, which is used for the second part printed with the special glossy ink of the special glossy region, are arranged in a plurality of second exclusive positions. Thus, the threshold values of the dither masks are respectively arranged in the exclusive positions, so that the special glossy ink and the color ink can be ejected to the exclusive positions in the special glossy region.

In another aspect, the group of the plurality of special glossy ink nozzles, which are substantially used in the special glossy ink nozzle array, partially overlap the group of the plurality of color ink nozzles, which are substantially used in the color ink nozzle array, in the sub-scanning direction. Thus, although the group of the special glossy ink nozzles substantially used partially overlap the group of the color ink nozzles, which are substantially used, in the sub-scanning direction, the average ejection timing of the special glossy ink is offset from the average ejection timing of the color ink, so that the color formation of the special glossy region printed with the special glossy ink and the color ink can be prevented from being reduced.

In another aspect, the special glossy ink has reflection angle dependence after the special glossy ink is printed on the print medium.

In another aspect, the special glossy ink includes pigments having metallic luster. Thus, the printing apparatus can print an image having a metallic glossy effect.

Another embodiment is directed to a printing method using a printing apparatus that prints an image on a print medium using special glossy ink and color ink, the printing apparatus including a print head including a special glossy ink nozzle array having a plurality of special glossy ink nozzles for ejecting the special glossy ink and a color ink nozzle array having a plurality of color ink nozzles for ejecting the color ink, the special glossy ink nozzle array and the color ink nozzle array being disposed in a sub-scanning direction while facing each other, and a print unit that drives the print head in a main scanning direction crossing the sub-scanning direction and carries the print medium in the sub-scanning direction relative to the print head; the printing method comprising: obtaining image data having a dedicated color region, on which printing is performed using only the color ink, a special glossy region on which the printing is performed using the color ink and the special glossy ink; and controlling the obtained image data to be printed on the print medium using a print controller that controls the print head and the print unit, performing the printing by ejecting the special glossy ink and the color ink at timings different from each other after a group of the special glossy ink nozzles, which are substantially used in the special glossy ink nozzle array, is offset from a group of the color ink nozzles, which are substantially used in the color ink nozzle array, in the sub-scanning direction by a predetermined interval, in a case of printing the obtained image data on the special glossy region; and performing the printing by using a relatively large number of the plurality of color ink nozzles as compared with the plurality of special glossy ink nozzles substantially used when the special glossy region is printed, in a case of printing the obtained image data on the dedicated color region.

Another embodiment is directed to an application program on a computer system for controlling a printing apparatus that prints an image on a print medium using special glossy ink and color ink, the application program causing the computer system to execute: obtaining image data having a dedicated color region, on which printing is performed using only the color ink, and a special glossy region on which the printing is performed using the color ink and the special glossy ink; controlling the obtained image data to be printed on the print medium using a print head and a print unit, and performing printing by ejecting the special glossy ink and the color ink at timings different from each other after a group of special glossy ink nozzles are offset from a group of color ink nozzles in a sub-scanning direction by a predetermined interval.

### BRIEF DESCRIPTION OF THE DRAWINGS

The invention will be described with reference to the accompanying drawings, wherein like numbers reference like elements.

FIG. 1 is a block diagram schematically showing the configuration of a printing system according to one embodiment of the invention.

FIG. 2 is a view showing image data including a dedicated color region and a special glossy region.

FIG. 3 is a view showing a normal dither mask.

FIG. 4 is a block diagram schematically showing a configuration of a computer.

FIG. 5 is a block diagram showing a configuration of a printer.

FIGS. 6A and 6B are views showing nozzle positions varying depending on print regions.

FIGS. 7A to 7C are views showing dots formed by a printer.

FIG. 8 is a view showing a special dither mask for color ink.

FIG. 9 is a view showing a halftone result obtained when a special dither mask is used and a dot recording rate is 10%.

FIG. 10 is a view showing a halftone result obtained when a special dither mask is used and a dot recording rate is 25%.

FIG. 11 is a view showing a special dither mask obtained by shifting a special dither mask by ½ period in a longitudinal direction.

FIG. 12 is a flowchart showing a printing process performed by a computer.

FIG. 13 is a flowchart showing a halftone processing routine.

FIG. 14 is a graph showing a first dot recording rate table.

FIG. 15 is a graph showing a second dot recording rate table.

FIG. 16A to 16C are views showing a print result according to a second embodiment.

FIG. 17A to 17C are views showing a print result according to a third embodiment.

FIGS. 18A and 18B are views showing a print result according to a fourth embodiment.

FIG. 19A to 19C are views showing a print result according to a fifth embodiment.

FIG. 20A to 20C are views showing a print result according to a sixth embodiment.

FIG. 21 is a view showing an example in which a precedent nozzle group partially overlaps a subsequent nozzle group.

FIG. 22 is a view showing an example in which unused nozzles are interposed between a precedent nozzle group and a subsequent nozzle group.

FIG. 23 is a view showing an example in which nozzles for ejecting metallic ink are offset from nozzles for ejecting color ink in a sub-scanning direction.

### DETAILED DESCRIPTION

### I. Printing System

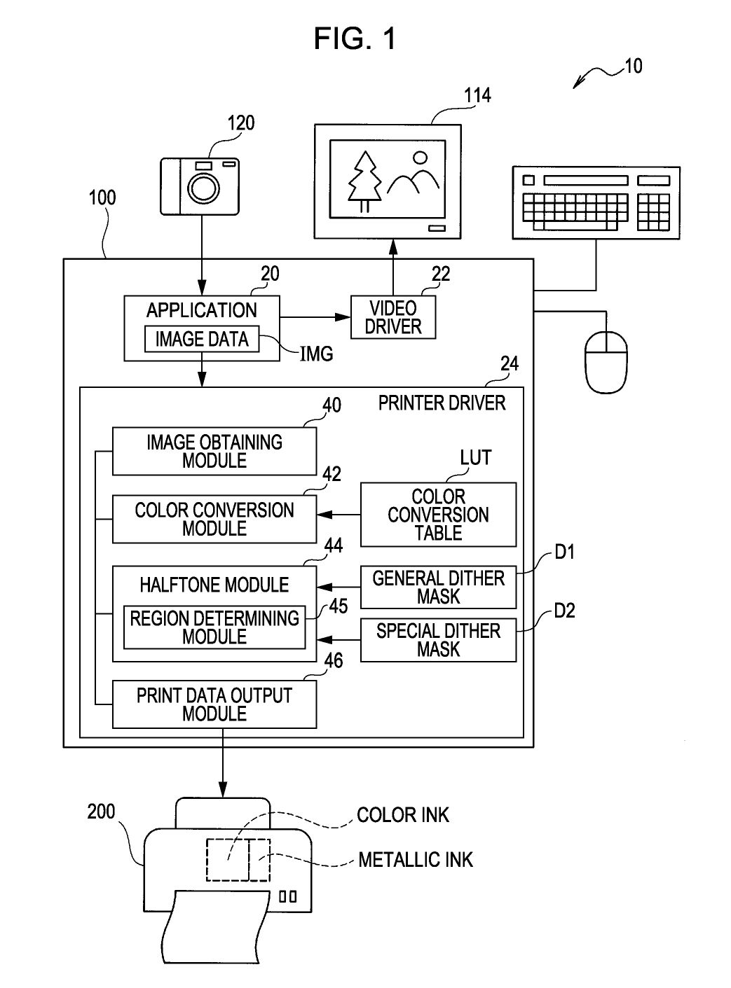

FIG. 1 is a block diagram schematically showing the configuration of the printing system 10 according to one embodiment of the invention. As shown in FIG. 1, the printing system 10 includes a computer 100 and a printer 200 that prints an image under the control of the computer 100. The printing system 10 may serve as a printing apparatus in a broad sense by allowing all the elements thereof to be integrally formed with each other.

The printer 200 according to the embodiment has Cyan ink C, Magenta ink M, Yellow ink Y and Black ink K which are dye-based color inks. According to one embodiment as described above, the color ink includes the Black ink. The printer 200 may also include other color inks, such as light Cyan ink, light Magenta ink, Dark Yellow ink and Red ink, in addition to the above inks.

Further, the printer 200 has special glossy ink such as metallic ink S that includes pigments producing a metallic glossy effect. In one embodiment, an oil-based ink composition including metal pigment, organic solvent and resin is used as the metallic ink S. In order to effectively obtain a metallic glossy effect, a 50% average particle diameter R50 of the particles, which corresponds to a diameter of a circle calculated from an area of the X-Y plane of the flat plate-shaped particles, may be about 0.5 μm to about 3 μm, and the formula R50/Z>5 is satisfied. For example, the metal pigment may be formed using aluminum or an aluminum alloy and may also be formed by crushing a metal deposition film. The above approach is especially effective when the above metal pigment includes flat plate-shaped particles having a long diameter of X, a short diameter of Y and a thickness of Z on a plane of the flat plate-shaped particles. The metal pigment included in the metallic ink may have a density of about 0.1 weight % to about 10.0 weight %. However, the metallic ink is not limited to the above composition. That is, the metallic ink may employ various compositions.

When the metallic ink is printed on a print medium, light is reflected from the part on which the metallic ink is printed. The metallic ink may have optical properties such as reflection angle dependence after the metallic ink is printed on the surface of the print medium. Metallic luster obtained by printing the metallic ink may be expressed by various indexes according to the reflection angle dependence. For example, an index value In1 expressed by Equation 1 below can be used as an index of the metallic luster. When light is irradiated onto the print medium at an angle of −45°, the index value In1 can be calculated using lightness of reflected light measured at three points defined by Equation 1.

$$In 1 = \frac{2.69 {( {L}_{1}^{*} - {L}_{3}^{*} )}^{1.11}}{{L}_{2}^{* 0.86}} \qquad Equation 1$$

L*₁: lightness when a light receiving angle is 30° (irradiation angle is −45°)

L*₂: lightness when a light receiving angle is 0° (irradiation angle is −45°)

L*₃: lightness when a light receiving angle is −65° (irradiation angle is −45°)

In addition, an index value In2 expressed by Equation 2 below or an index value In3 expressed by Equation 3 below can be used as the index of the metallic luster.

$$\begin{matrix}In 2 = \frac{3 ( {L}_{1}^{*} - {L}_{3}^{*} )}{{L}_{2}^{*}} & Equation 2 \\ In 3 = {L}_{1}^{*} - {L}_{3}^{*} & Equation 3\end{matrix}$$

The computer 100 as shown in FIG. 1 includes a predetermined operating system installed therein, and application program 20 executed under the control of the operating system. The operating system has a video driver 22 and a printer driver 24 therein. For example, the application program 20 receives image data IMG from a digital camera 120 through a peripheral device interface 108. Then, the application program 20 displays an image, which is represented by the image data IMG, on a display 114 through the video driver 22. Further, the application program 20 outputs the image data IMG to the printer 200 through the printer driver 24. The image data IMG, which is received in the application program 20 from the digital camera 120, includes the three primary colors of red R, green G and blue B.

The application program 20 according to one embodiment can generate image data including a region (hereinafter, referred to as a dedicated color region A1), which is formed of the three primary colors of red R, green G and blue B, and a region (hereinafter, referred to as a special glossy region A2), in which metallic color is defined as the background color and a color image including the three primary colors of red R, green G and blue B overlaps the metallic color. The image data is obtained by adding information (hereinafter, referred to as range information) representing the range of the special glossy region A2 to normal RGB image data. The range information can be represented by a vector or a raster.

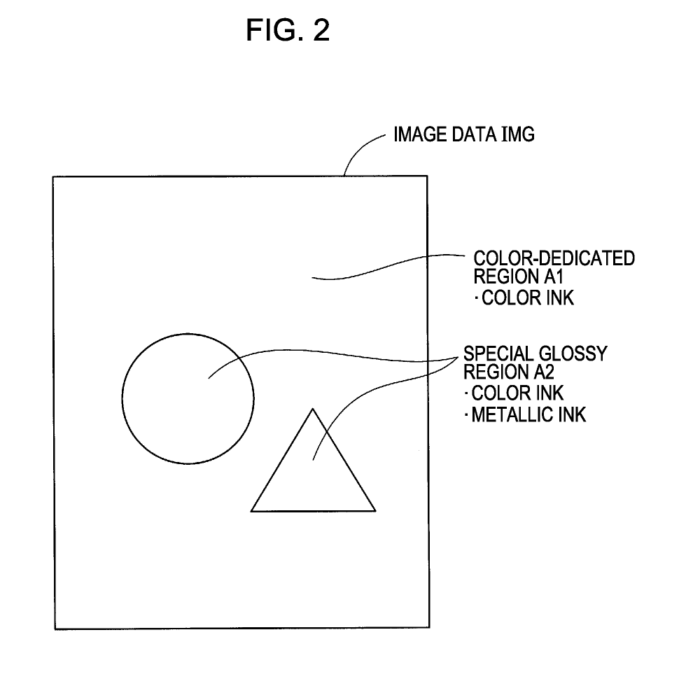

FIG. 2 is a view showing an example of the image data IMG including the dedicated color region A1 and the special glossy region A2. As shown in FIG. 2, a circle and a triangle are designated as the special glossy region A2 and the background is designated as the dedicated color region A1.

The printer driver 24 corresponding to an obtaining unit and a printing controller according to one embodiment includes an image obtaining module 40, a color conversion module 42, a halftone module 44 and a print data output module 46. The image obtaining module 40 obtains the image data, which is to be printed, from the application program 20.

The color conversion module 42 converts color components RGB of color parts in the dedicated color region A1 and the special glossy region A2 of the image data into color components, such as Cyan C, Magenta M, Yellow Y and Black K, which can be expressed through the printer 200, with reference to a predetermined color conversion table LUT.

The halftone module 44 performs halftone processing relative to the color-converted image data such that the image data is represented by distribution of binarized (multi-value) dots. According to the embodiment, the ordered dither method is used for the halftone processing. Further, in addition to the ordered dither method, an error diffusion method, a tone production method by density pattern, and a halftone technology can be used for the halftone processing.

In one embodiment, the halftone module 44 includes a region determining module 45. The region determining module 45 determines the special glossy region A2 and the dedicated color region A1 from the image data IMG received from the application program 20. More specifically, the region determining module 45 determines a region included in the range information stored in the image data IMG as the special glossy region A2, and determines the other regions as the dedicated color region A1.

If the special glossy region A2 and the dedicated color region A1 of the image data IMG are determined by the region determining module 45, the halftone module 44 performs the halftone processing using dither masks that vary depending on the determined regions. The dither mask used for the dedicated color region A1 is a normal dither mask (hereinafter, referred to as a normal dither mask D1) having blue noise characteristics.

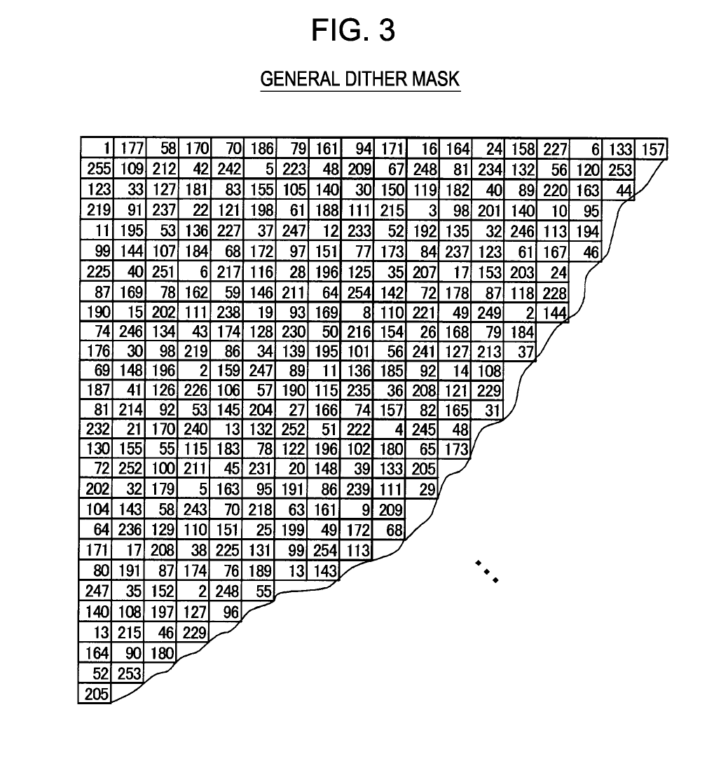

FIG. 3 is a view showing an example of the normal dither mask D1. When an image is binarized using the normal dither mask D1, threshold values are arranged in elements of the normal dither mask D1 such that the image has the blue noise characteristics. The dither mask used for the special glossy region A2 is a special dither mask (hereinafter, referred to as a special dither mask D2), which is generated in order to form dots of metallic color prior to dots of color. The special dither mask D2 will be described in detail later.

The print data output module 46 rearranges the data, which represents the arrangement of dots of each color obtained through the halftone processing, according to a dot formation sequence by the print head 241 of the printer 200, and outputs the rearranged data to the printer 200 as print data.

In one embodiment, the printer driver 24 determines the special glossy region A2 and the dedicated color region A1 from the image data. Then, the printer driver 24 performs printing relative to the special glossy region A2 by using the metallic ink and the color ink, and performs printing relative to the dedicated color region A1 by using only the color ink. The metallic color is not generated by the color conversion module 42 through the color conversion from each value of RGB, but is used for the special glossy region A2 represented by the range information stored in the image data by the application program 20. That is, in one embodiment, the metallic ink is used based on a specific design request for a background color of a label sheet or a background color distinguished from other parts, instead of being used for reproducing a natural image.

### II. Configuration of the Computer and the Printer

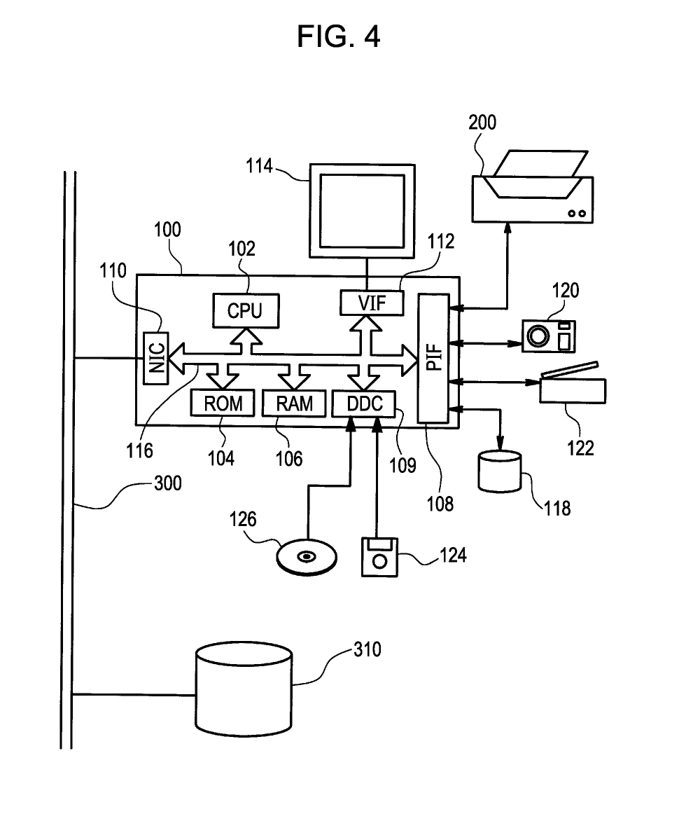

FIG. 4 is a block diagram schematically showing a configuration of the computer 100. The computer 100 is generally known in the art and includes a CPU 102, a ROM 104, a RAM 106 and the like, which are connected with each other through a bus 116.

The computer 100 includes a disk controller 109 for reading data from a flexible disk 124 and a compact disk 126, a peripheral device interface 108 for transmitting/receiving data to/from a peripheral device, and a video interface 112 for driving a display 114. The peripheral device interface 108 is connected with the printer 200 and a hard disk 118. Further, if the digital camera 120 or a color scanner 122 is connected to the peripheral device interface 108, image processing can be performed relative to images obtained through the digital camera 120 or the color scanner 122. Further, if a network interface card 110 is installed at the computer 100, the computer 100 can read data stored in a memory device 310 connected to a communication line 300. When image data to be printed is obtained, the computer 100 prints the image data by controlling the printer 200 through the printer driver 24.

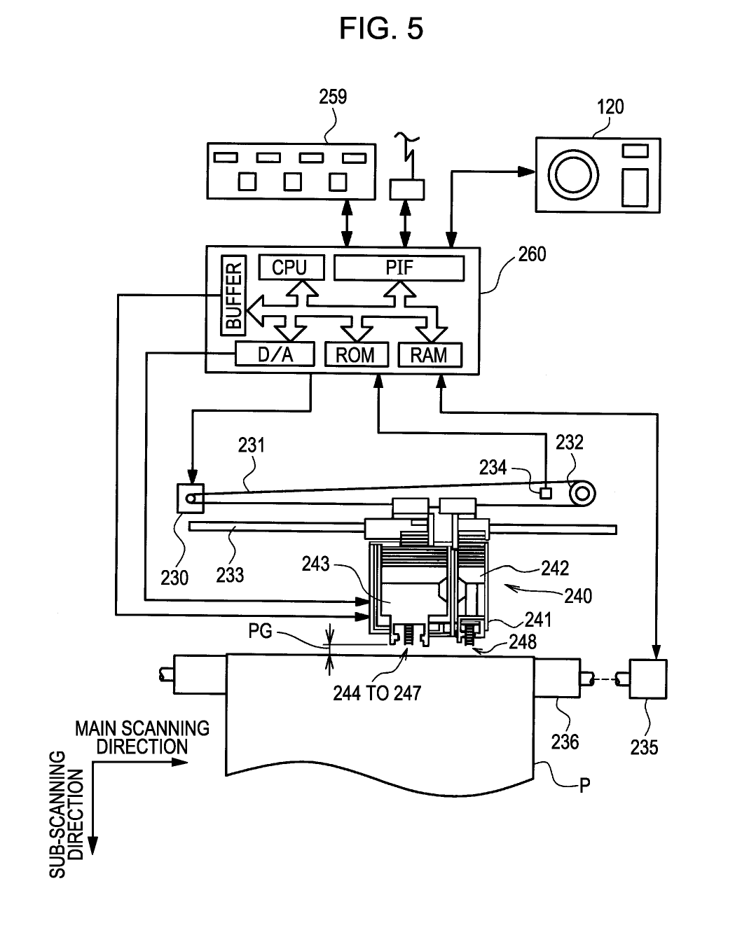

The configuration of the printer 200 will now be described with reference to FIG. 5. As shown in FIG. 5, the printer 200 includes a transfer mechanism that transfers a print medium P using a sheet transfer motor 235, a main scanning mechanism that allows a carriage 240 to reciprocate in an axial direction of a platen 236 using a carriage motor 230, a mechanism that drives the print head 241 mounted on the carriage 240 to eject ink and form dots, and a control circuit 260 that controls signal exchange among the sheet transfer motor 235, the carriage motor 230, the print head 241 and a manipulation panel 256.

The main scanning mechanism, which allows the carriage 240 to reciprocate in the axial direction of the platen 236, includes a sliding shaft 233, which is installed in parallel to a shaft of the platen 236 such that the carriage 240 can slide, a driving belt 231 installed between a pulley 232 and the carriage motor 230, and a position sensor 234 that detects the original position of the carriage 240.

The carriage 240 includes a color ink cartridge 243 that stores the color ink such as Cyan ink C, Magenta ink M, Yellow ink Y and Black ink K. Further, the carriage 240 includes a metallic ink cartridge 242 that stores the metallic ink S. The print head 241 provided at a lower portion of the carriage 240 includes arrays 244 to 248 of nozzles for ejecting the ink, which are provided for each color. The ink cartridges 242 and 243 are installed in the carriage 240 from the top to the bottom, so the ink can be supplied to the nozzle arrays 244 to 248 from the cartridges 242 and 243. Further, as described later, the nozzles provided in the print head 241 can eject ink droplets having large, medium and small sizes to form dots having large, medium and small sizes on the print medium. On the basis of the large dot, the medium dot corresponds to about a half of the large dot and the small dot corresponds to about ¼ of the large dot.

The control circuit 260 includes the CPU, the ROM, the RAM and the peripheral device interface (PIF), which are connected with each other through the bus. If the print data is received from the computer 100 through the PIF, the control circuit 260 drives the carriage motor 230 to allow the heads 244 to 247, which eject the ink of each color, to reciprocate relative to the print medium P in the main scanning direction. Further, the control circuit 260 drives the sheet transfer motor 235 to move the print medium P in the sub-scanning direction. The control circuit 260 forms ink dots of predetermined colors at predetermined positions on the print medium P by driving the nozzles at proper timing based on the print data according to the reciprocation (main scanning) of the carriage 240 and the movement (sub-scanning) of the print medium P. In this way, the printer 200 can print a color image on the print medium P. Further, according to the embodiment, the print medium P is transferred in the sub-scanning direction. However, the embodiment of the invention is not limited thereto. That is, the carriage 240 may be transferred in the sub-scanning direction by fixing the position of the print medium P.

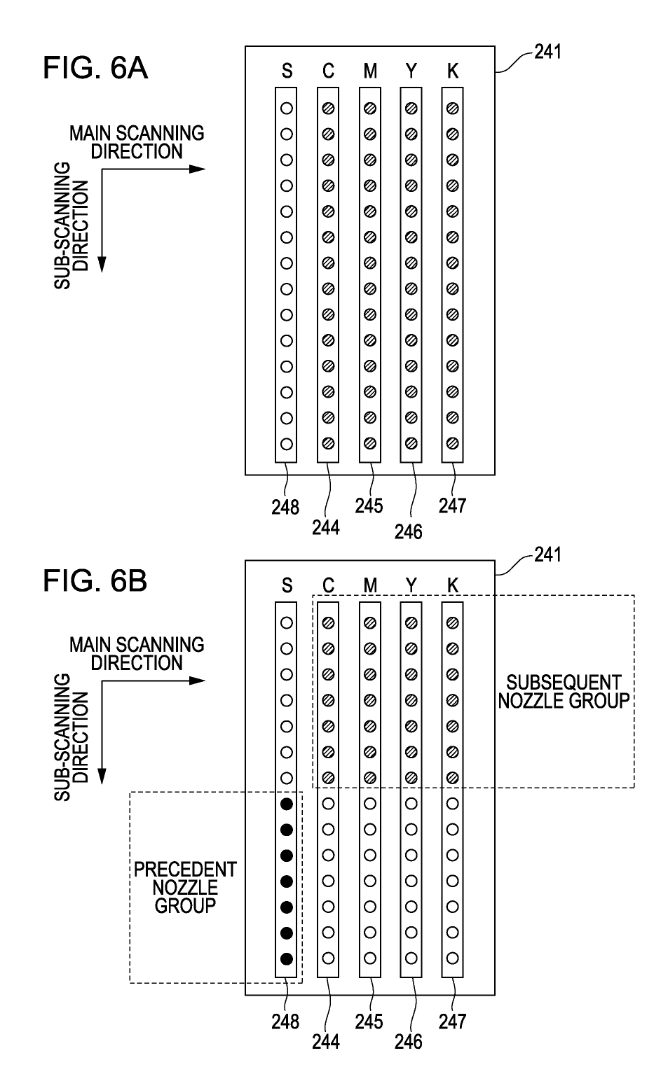

In one embodiment, the printer 200 prints images on the dedicated color region A1 and the special glossy region A2 by varying the positions of nozzles used from among a plurality of nozzles. FIGS. 6A and 6B are views showing the positions of nozzles varying depending on the print regions. FIG. 6A is a view showing the arrangement of the nozzles when the dedicated color region A1 is printed and FIG. 6B is a view showing the arrangement of the nozzles when the special glossy region A2 is printed. Referring to FIGS. 6A and 6B, black circles represent nozzles actually used from among nozzles capable of ejecting the metallic ink, and hatched circles represent nozzles actually used from among nozzles capable of ejecting the color ink. Further, white circles represent nozzles which are not actually used. As shown in FIGS. 6A and 6B, the print head 241 includes the nozzle arrays, which have the nozzles capable of ejecting the metallic ink, and the nozzle arrays, which have the nozzles capable of ejecting the color ink, which face each other in the sub-scanning direction.

As shown in FIG. 6A, the printer 200 performs the printing operation relative to the dedicated color region A1 by using all the nozzles prepared to eject the color ink, without using the nozzles prepared to eject the metallic ink. Further, the printer 200 performs the printing operation relative to the special glossy region A2 by using 7 nozzles (hereinafter, referred to as a precedent nozzle group), which primarily pass the print medium P, of the 14 nozzles for ejecting the metallic ink, and does not use the remaining 7 nozzles. Further, in relation to the nozzle arrays 244 to 247 of the color inks C, M, Y and K, 7 nozzles of the 14 nozzles, which primarily pass the print medium P, are not used, and the remaining 7 nozzles are used. Hereinafter, the remaining 7 nozzles will be referred to as a subsequent nozzle group. According to one embodiment, when the special glossy region A2 is printed, the precedent nozzle group is offset from the subsequent nozzle group by a predetermined interval in the sub-scanning direction as shown in FIG. 6B, so the metallic ink is ejected on the same area of the print medium P, and then the color ink is ejected.

As it can be seen from FIGS. 6A and 6B, in one embodiment, the metallic part and the color part in the special glossy region A2 are printed using the nozzles having a smaller number (more specifically, half the total number of the nozzles) as compared with the number of the nozzles used for the dedicated color region A1. Thus, the number of main scannings of the print head 241 for filling a predetermined local region in the dedicated color region A1 with the color ink is increased (in detail, twofold) as compared with the number of main scannings of the print head 241 for filling a local region.

### III. Nozzle Arrangement Control According to the Dither Masks

The arrangement of the nozzles actually used for a region to be printed can be changed by applying the special dither mask D2 to the special glossy region A2 when the halftone processing is performed by the printer driver 24. This principle will now be described in detail.

In one embodiment, the print head 241 is controlled on the assumption that the number of overlappings is 2, a nozzle pitch is 2, a sheet transfer rate is 7, and bi-directional printing is performed to continuously eject ink while the print head 241 is reciprocating. The number of overlappings represents the number of main scannings required when one line formed in the main scanning direction (transverse direction) is filled with dots. More specifically, when the number of overlappings is 2, one line in the main scanning direction is filled with dots by performing the main scannings two times. The nozzle pitch represents the number of lines (dots) between two nozzles. In one embodiment, when the nozzle pitch is 2, the main scanning of the print head 241 is performed once, so dots are formed every other line. Further, the sheet transfer rate represents the number of lines by which the print head 241 moves in the sub-scanning direction when the main scanning is performed once. In one embodiment, since the sheet transfer rate is 7 (odd number), new dots are formed at a gap between dots, which are primarily formed every other line, through the next main scanning.

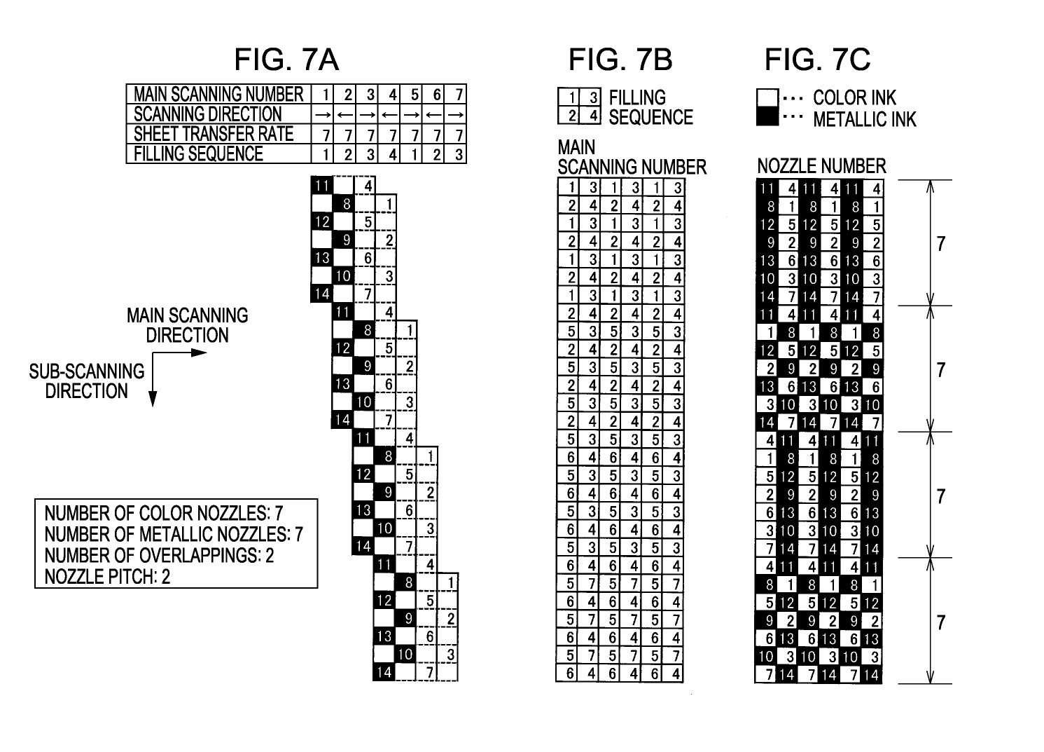

FIGS. 7A to 7C are views showing dots formed by the printer 200. First, the following description will be given on the assumption that the metallic ink can be ejected through only the precedent 7 nozzles in the sub-scanning direction of the nozzle array including the 14 nozzles, instead of the remaining 7 nozzles, and the color ink can be ejected through only the remaining 7 nozzles, instead of the precedent 7 nozzles. Further, it is assumed that the metallic nozzle group and the color nozzle group are included in the same nozzle array. FIG. 7A is a view showing the nozzle array shifted in the sub-scanning direction when the main scanning is performed. The numerical values 1 to 7 assigned to the nozzle array as shown in FIG. 7A represent nozzles that eject the color ink, and the numerical values 8 to 14 represent nozzles that eject the metallic ink. As shown in FIG. 7A, in one embodiment, since the sheet transfer rate is 7, the print head 241 is shifted by 7 lines (7 nozzles) in the sub-scanning direction whenever the main scanning is performed.

FIG. 7B is a view showing the sequence of the main scanning in which dots are formed on the print medium. Each lattice as shown in FIG. 7B, corresponds to one dot on the print medium, and the numerical value assigned to the lattice corresponds to the main scanning number shown in the uppermost portion of FIG. 7A. That is, referring to FIG. 7B, in the uppermost line, dots in an odd sequence are formed when the first main scanning is performed, and dots in an even sequence are formed when the third main scanning is performed.

As shown in FIG. 7B, in one embodiment, when a local region having a size of 2×2 is defined, dots in the local region are filled in the sequence of the left upper part, the left lower part, the right upper part and the right lower part. This sequence will be referred to as a filling sequence. The size of the local region coincides with the number (i.e. 2) of overlappings in the transverse direction (main scanning direction), and the nozzle pitch (i.e. 2) in the longitudinal direction (sub-scanning direction). The filling sequence may be changed whenever the print head 241 is shifted in the sub-scanning direction, that is, whenever the main scanning is performed. In one embodiment, when the filling sequence is changed four times, it returns to the original filling sequence. The filling sequence is set by a predetermined command transmitted from the printer driver 24 to the control circuit 260 of the printer 200. If the command for the filling sequence is received from the printer driver 24, the control circuit 260 forms the dots in the filling sequence represented by the command.

FIG. 7C is a view showing nozzles through which dots are formed on the print medium. The numerical values assigned to the lattices correspond to the nozzle numbers as shown in FIG. 7A. Referring to FIGS. 7B and 7C, dots in an odd sequence on the uppermost line are formed through the 11^{th} nozzle when the first main scanning is performed, and dots in an even sequence are formed through the fourth nozzle when the third main scanning is performed. Further, in relation to the second line, dots in an odd sequence are formed through the eighth nozzle when the second main scanning is performed, and dots in an even sequence are formed through the first nozzle when the fourth main scanning is performed.

Referring to FIG. 7C, the dots formed through the nozzles having numbers 8 to 14, that is, the nozzles for the metallic ink, are indicated by the black lattices, and the dots formed through the nozzles having numbers 1 to 7, that is, the nozzles for the color ink, are indicated by the white lattices. As described above, after the dots formed by the metallic ink are distinguished from the dots formed by the color ink based on the colors of the dots, the nozzles for the color ink are offset from the nozzles for the metallic ink in the head in the sub-scanning direction, so a specific pattern (shape) is generated on the print medium. The pattern as shown in FIG. 7C is changed in the unit of 7 lines (hereinafter, referred to as a band unit), which corresponds to the sheet transfer rate. The pattern returns to the original pattern whenever the filling sequence is repeated in one cycle.

As described above, the metallic ink is ejected through the precedent 7 nozzles of the 14 nozzles, and the color ink is ejected through the remaining 7 nozzles of the 14 nozzles. However, when taking the result of FIG. 7C into consideration, as long as the pattern as shown in FIG. 7C is printed, the metallic ink is ejected through only the precedent 7 nozzles of the 14 nozzles and the color ink is ejected through only the remaining 7 nozzles of the 14 nozzles. That is, if the dither mask, which generates the pattern as shown in FIG. 7C through the halftone processing, is prepared in advance as the special dither mask D2, the arrangement pattern of the nozzles may vary depending on the dither mask being used.

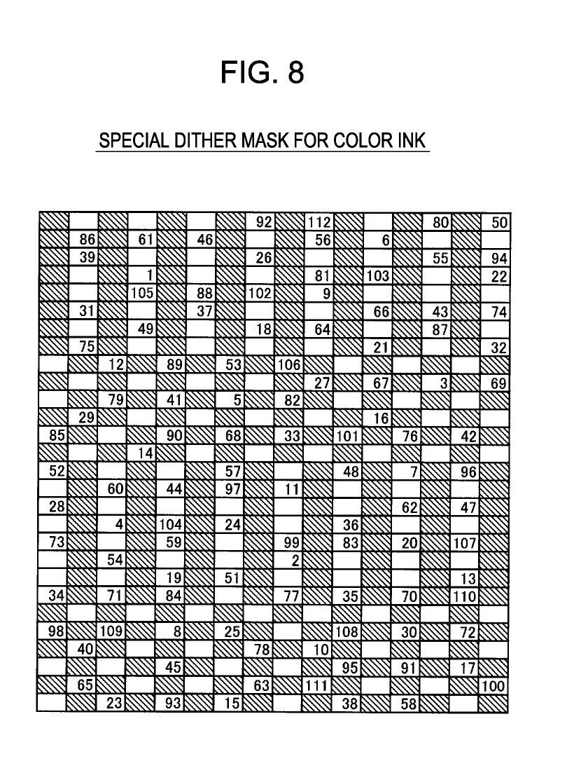

FIG. 8 is a view showing an example of the special dither mask D2 for color ink used in one embodiment. As shown in FIG. 8, the special dither mask D2 is generated based on the pattern as shown in FIG. 7C. The special dither mask D2 has a size ‘16’ in the transverse direction, which is an integer time (i.e. eight times) of the number of overlappings, and has a size ‘28’ in the longitudinal direction, which is an integer time (i.e. one time) of the pattern as shown in FIG. 7C. If the special dither mask D2 is a normal dither mask, threshold values of 1 to 488 (=16×28) are arranged in elements of the special dither mask D2. Thus, when the comparison data has a value smaller than the threshold value, dots are turned off. However, when the comparison data has a value equal to or larger than the threshold value, the dots are turned on. In this way, data in the range of 0 to 488 can be binarized. However, according to the special dither mask D2 for the color ink as shown in FIG. 8, the threshold values are substantially arranged only to positions (i.e. positions where color dots are formed) corresponding to white lattices as shown in FIG. 7C. Further, values which exceed the maximum value of the dot recording rate compared with the threshold values of the special dither mask D2, are set at positions (i.e. positions where metallic dots are formed) corresponding to black lattices as shown in FIG. 7C. If the values, which exceed the maximum value of the dot recording rate, are set at the positions where the metallic dots are formed, no dots are formed at the positions. Thus, if the special dither mask D2 as shown in FIG. 8 is used, only the color dots can be formed. Further, when special codes are arranged at the hatched parts of FIG. 8 and the halftone processing is performed relative to the hatched parts, comparison of the parts having the codes and the threshold values is skipped, so dots can be prevented from being formed on the parts. Further, FIG. 8 shows the threshold values equal to or less than ½, instead of showing all threshold values.

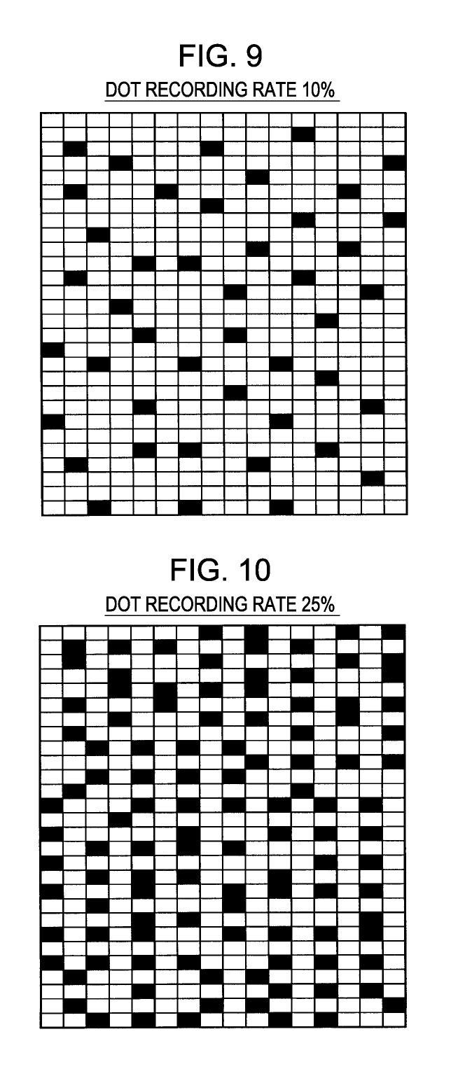

FIG. 9 is a view showing a halftone result when the special dither mask D2 as shown in FIG. 8 is used and the dot recording rate is 10%, and FIG. 10 is a view showing a halftone result when the special dither mask D2 as shown in FIG. 8 is used and the dot recording rate is 25%. As shown in FIGS. 9 and 10, if the threshold values are optimally arranged on the special dither mask D2, even if the special dither mask D2 causes the generation of the pattern as shown in FIG. 7C, superior dot distribution can be achieved up to a predetermined dot recording rate.

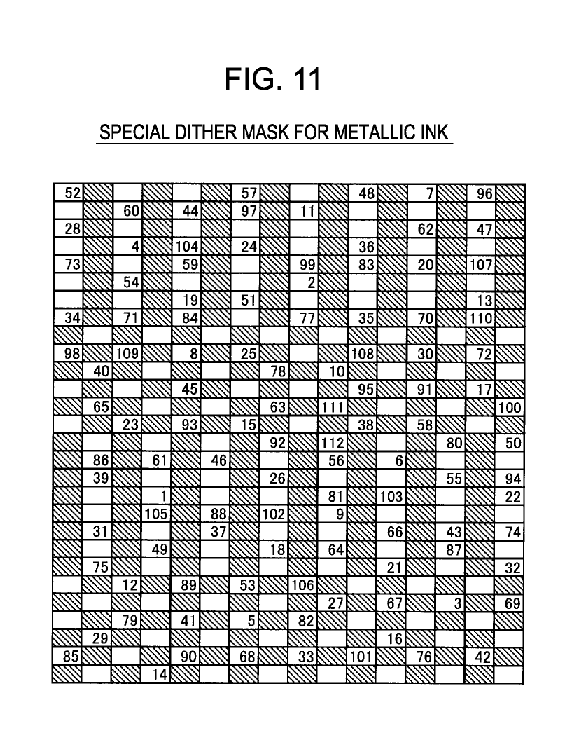

Further, FIG. 8 shows the special dither mask D2 for the color ink, which will be referred to as a special dither mask D2a. According to the embodiment, a dither mask obtained by shifting the special dither mask D2a by ½ period (corresponding to 14 lines) in the longitudinal direction is used as a special dither mask for the metallic ink, which will be referred to as a special dither mask D2b. In the pattern as shown in FIG. 7C, the metallic parts and the color parts are completely exchanged at a period of ½ (corresponding to 14 lines) in the longitudinal direction. Thus, the special dither mask D2a is shifted by ½ period in the longitudinal direction, so that the arrangement of the threshold values can be used for the metallic ink. FIG. 11 is a view showing an example of the special dither mask D2b obtained by shifting the special dither mask D2a by ½ period in the longitudinal direction. When the special dither mask D2a as shown in FIG. 8 is compared with the special dither mask D2b as shown in FIG. 11, the threshold values are arranged on exclusive positions of the two special dither masks D2a and D2b, except for the hatched parts which do not actually serve as the threshold values. Thus, in relation to the special glossy region A2 to which the special dither masks D2a and D2b are applied, dots formed by the metallic ink and dots formed by the color ink are arranged at the exclusive positions, respectively.

The computer 100 individually recognizes the two types of the special dither masks D2a and D2b. That is, the computer 100 performs the halftone processing by individually using the three types of the general dither mask D1, the special dither mask D2a for the color ink, and the special dither mask D2b for the metallic ink. Hereinafter, the printing process using the dither masks will be described in detail.

### IV. Printing Process

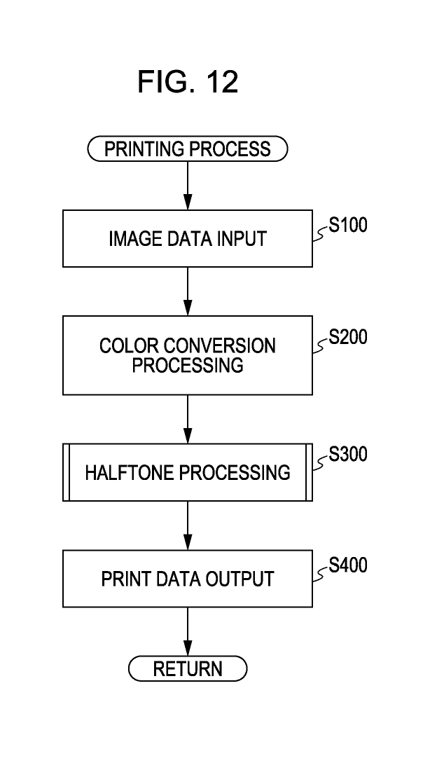

FIG. 12 is a flowchart showing the printing process performed by the computer 100 according to one embodiment. The printing process is performed when the CPU 102 (hardware) executes the printer driver 24 prepared in the form of an application program. When the printing process starts, the computer 100 receives RGB image data including the dedicated color region A1 and the special glossy region A2 from the application program 20 (Step S100). As described above, the image data includes a range of the special glossy region A2 as the range information.

Next, the computer 100 converts the RGB image data received in Step S100 to CMYK image data by using the color conversion module 42 (Step S200). Through such color conversion, the color parts of the dedicated color region A1 and the special glossy region A2 have the CMYK format from the RGB format.

After the CMYK image data is obtained, the computer 100 performs the halftone processing relative to colors of Cyan C, Magenta M, Yellow Y, Black K and Metallic S by using the halftone module 44 to generate data which can be transmitted to the printer 200 (Step S300). The data which can be transmitted to the printer 200 denotes data (hereinafter, referred to as dot data) representing the size of ink droplets formed on the print medium P, which may form small dots, medium dots and large dots or not.

In one embodiment, in Step S300, the halftone processing is performed for the metallic ink, which is printed on the special glossy region A2, with a density of 25%. The above density can be properly selected by a user. For example, a user interface may be provided on a setup screen of the printer driver 24 such that the density of the metallic color printed on the special glossy region A2 can be selected, and the user can properly set the density of the metallic color through the user interface. Further, the user can set the density of the metallic color by using the function of the application program 20 that can store the setting value in the image data as additional information. The printer driver 24 can determine the density of the metallic ink, which is printed on the special glossy region A2, with reference to the additional information.

After the halftone processing is completed, the computer 100 outputs each dot data, which corresponds to the C, M, Y, K and S generated through the halftone processing, to the printer 200 through the print data output module 46 as print data (Step S400).

The printer 200 receives the print data output from the computer 100, and prints an image by ejecting the ink on the print medium according to the received print data. In one embodiment, the printer 200 controls the print units such as the print head 241, the carriage motor 230 and the sheet transfer motor 235 under the printing conditions where the number of overlappings is 2, the nozzle pitch is 2, the sheet transfer rate is 7, and the bi-direction printing is performed.

The halftone processing performed in Step S300 of the printing process will now be described in detail.

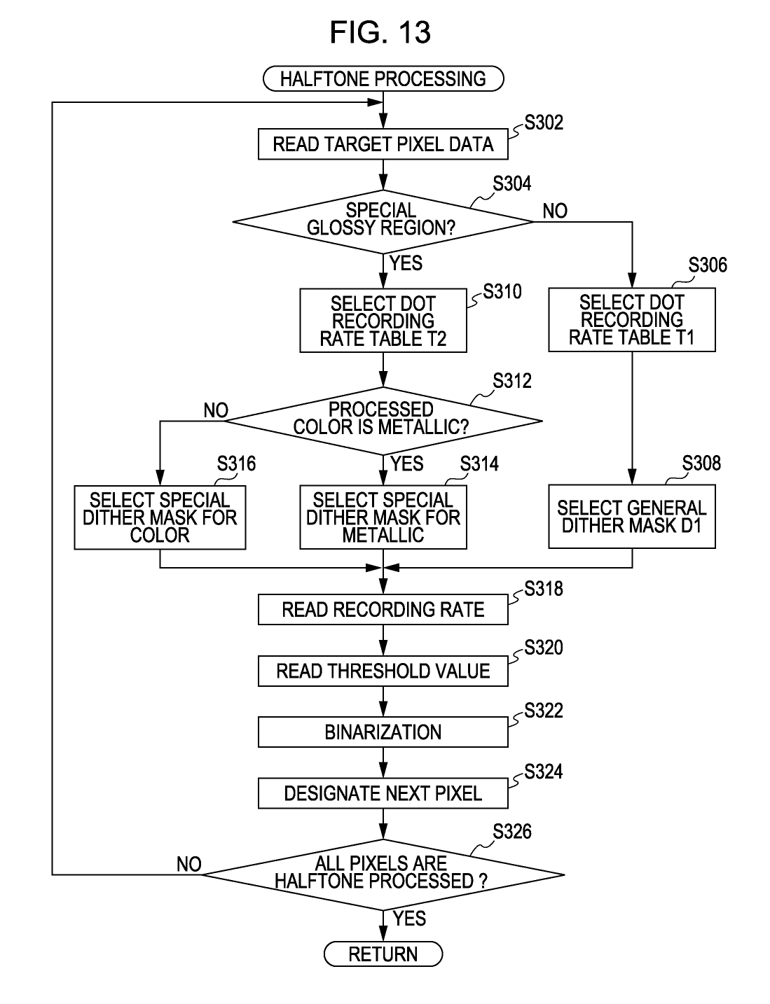

FIG. 13 is a flowchart showing the halftone processing routine. The halftone processing is performed for the colors of the C, M, Y, K and S. As shown in FIG. 13, when the halftone processing starts, the computer 100 reads gray scale data of a target pixel (Step S302). The target pixel has an initial position corresponding to the upper left corner of the image data. Further, as described above, the halftone processing is performed for the gray scale data of the metallic color with the density of 25%.

After the gray scale data of the target pixel is read in Step S302, the computer 100 determines whether the position of the target pixel is included in the special glossy region A2 with reference to the range information stored in the image data (Step S304). If it is determined that the position of the target pixel is not included in the special glossy region A2, that is, if the position of the target pixel is included in the dedicated color region A1, the computer 100 selects a dot recording rate table T1 (Step S306) and selects the general dither mask D1 (Step S308). According to the dot recording rate table T1, the generation rates of small, medium and large dots generated on the target pixel are defined according to the gray scale data of target pixel. The dot recording rate table T1 will be described in detail later.

In Step S304, if it is determined that the position of the target pixel is included in the special glossy region A2, the computer 100 selects a dot recording rate table T2 (Step S310) and determines whether the color being processed is metallic (Step S312). If the color being processed is metallic, the computer 100 selects the special dither mask D2b for the metallic color (Step S314). However, if the color being processed is another color such as a CMYK color, the computer 100 selects the special dither mask D2a for the color (Step S316).

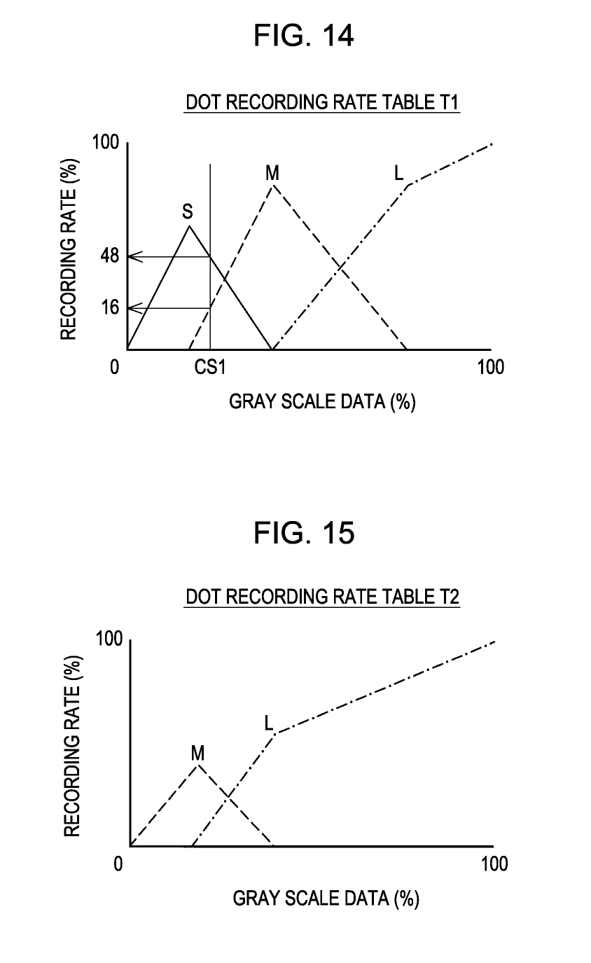

FIGS. 14 and 15 are graphs showing an example of the dot recording rate tables T1 and T2 selected in Steps S306 and S310. As shown in FIG. 14, the formation rates of large, medium and small dots for CMYK colors have been set in the dot recording rate table T1. According to the dot recording rate table T1, a recording rate S of the small dots is gradually increased up to the maximum value in a range of 0 to 15 of the gray scale data, and then gradually reduced so that the recording rate S of the small dots reaches 0 when the gray scale data has a value of 40. A recording rate M of the medium dots is gradually increased up to the maximum value in a range of 15 to 40 of the gray scale data, and then gradually reduced so that the recording rate M of the medium dots reaches 0 when the gray scale data has a value of 80. Further, a recording rate L of the large dots is gradually increased until the maximum value in a range of 40 to 100 of the image data. More specifically, the slope of increase in the recording rate L is smooth in a range of 80 or more of the gray scale data, as compared with a range of 80 or less of the gray scale data.

Meanwhile, as shown in FIG. 15, the recording rates of medium and large dots have been set in the dot recording rate table T2, except for the recording rate S of the small dots. According to the dot recording rate table T2, the recording rate M of the medium dots is gradually increased until the recording rate M reaches 30% of the maximum value in a range of 0 to 20 of the gray scale data, and then gradually reduced so that the recording rate M of the medium dots reaches 0 when the gray scale data has a value of 40. Further, the recording rate L of the large dots is gradually increased up to the maximum value in a range of 20 to 100 of the gray scale data. More specifically, the slope of increase in the recording rate L is smooth in a range of 40 or more of the gray scale data, as compared with a range of 40 or less of the gray scale data.

When the dot recording rate table T1 is compared with the dot recording rate table T2, the dot recording rate table T1 defines the recording rates of the large, medium and small dots, and the dot recording rate table T2 defines the recording rates of the medium and large dots. Thus, in the case of the same gray scale data, if the dot recording rate table T2 is used instead of the dot recording rate table T1, dots having a larger size can be formed.

After a dither mask is selected in one of Steps S308, S314 and S316, the computer 100 reads a dot recording rate, which corresponds to the gray scale data read in Step S302, from the dot recording rate table T1 or T2 selected in Step S306 or S310 (Step S318). Then, the computer 100 reads a threshold value corresponding to the position of the target pixel from the dither mask is selected in one of Steps S308, S314 and S316 (Step S320), and performs binarization using an ordered dither method based on the dot recording rate read in Step S318 and the threshold value read in Step S320 (Step S322). Since the ordered dither method is generally known in the art, detailed description thereof will be omitted. However, as a result of comparing the recording rate corresponding to the gray scale data of the target pixel with the threshold value of the dither mask corresponding to the position of the target pixel, if the recording rate is larger than the threshold value, it is determined that dots are formed on the target pixel. In contrast, if the recording rate is smaller than the threshold value, it is determined that no dots are formed on the target pixel.

Referring to the dot recording rate table T1 or T2, two or more types of the dot recording rates may be read. For example, in the dot recording rate table T1 as shown in FIG. 14, two types of the dot recording rates, that is, the recording rate S of the small dots and the recording rate M of the medium dots may be read as 48 and 16 with respect to the gray scale data CS1. In such a case, the computer 100 determines the size of the dots formed on the target pixel according to the following processing sequence.

First, the recording rate L of the large dots is compared with the threshold value. If the recording rate L of the large dots is larger than the threshold value, it is determined that the large dots are formed on the target pixel. If the recording rate L of the large dots is smaller than the threshold value, a sum (L+M) of the recording rate L of the large dots and the recording rate M of the medium dots is compared with the threshold value. If the sum (L+M) is larger than the threshold value, it is determined that the medium dots are formed on the target pixel. Finally, if the sum (L+M) is smaller than the threshold value, a sum (L+M+S) of the recording rate L of the large dots, the recording rate M of the medium dots and the recording rate S of the small dots is compared with the threshold value. If the sum (L+M+S) is larger than the threshold value, it is determined that the small dots are formed on the target pixel. In contrast, if the sum (L+M+S) is smaller than the threshold value, it is determined that no dots are formed on the target pixel.

For example, when the recording rate L of the large dots is 0, the recording rate M of the medium dots is 16, the recording rate S of the small dots is 48, and the threshold value is 30, a method of determining the size of the dots is based on the above processing sequence. That is, since the recording rate L of the large dots is smaller than the threshold value, it is determined that no large dots are formed. Then, a sum (i.e. 16) of the recording rate L of the large dots and the recording rate M of the medium dots is compared with the threshold value 30. However, since the sum is smaller than the threshold value, a sum (i.e. 64) of the recording rate L of the large dots, the recording rate M of the medium dots and the recording rate S of the small dots is compared with the threshold value 30. As a result of the comparison, since the sum (L+M+S) is larger than the threshold value, it is determined that the small dots are formed. As described above, the recording rates of the dots having various sizes are sequentially added and then the sum of the recording rates is compared with the threshold value, so the size of dots to be formed can be determined based on one threshold value.

If the halftone processing for the target pixel is completed as described above, the computer 100 designates a next pixel (Step S324), and determines whether the halftone processing has been performed relative to all pixels (Step S326). If the halftone processing has not been performed relative to all pixels, the procedure returns to Step S302 and the above steps are repeated. In contrast, if the halftone processing has been performed relative to all pixels, the computer 100 ends the halftone processing.

If the halftone processing ends, the print data generated through the halftone processing is transmitted to the printer 200. The printer 200 receives the print data, drives the print head 241 under the printing conditions that the number of overlappings is 2, the nozzle pitch is 2, and the sheet transfer rate is 7 as described above, and performs the bi-directional printing in which ink is continuously ejected while the print head 241 is reciprocating. Thus, as shown in FIGS. 7A and 7B, in relation to the dedicated color region A1, the printing is performed using all nozzles for the color ink. Further, in relation to the special glossy region A2, the metallic ink is printed using the precedent nozzle group and the color ink is printed using the subsequent nozzle group. Thus, the metallic ink is primarily printed on the special glossy region A2, so the drying of the metallic ink can be facilitated. As a result, mixing of the metallic ink and the color ink can be prevented, so that the color formation of the metallic ink and the color ink can be improved.

In one embodiment, the dedicated color region A1 is printed using a relatively large number of nozzles, as compared with the number of nozzles used when the special glossy region A2 is printed. In other words, the number of the main scannings for filling the dedicated color region A1 with the dots of the color ink is larger than the number of the main scannings for filling the special glossy region A2 with the dots of the color ink or the metallic ink. As a result, the printing speed for the dedicated color region A1 is improved, so the speed at which an entire image is printed is significantly increased, as compared with a case in which all print regions are printed after initially grouping the nozzles into the precedent nozzle group and the subsequent nozzle group.

In one embodiment, the dither mask used for the halftone processing is changed according to the print region, so that the arrangement of nozzles actually used can be controlled. Thus, a circuit, which determines whether to use the nozzles by transmitting a special control signal to the nozzles, is not necessary, so that the arrangement of the nozzles can be changed without modifying the configuration of an existing printer.

In one embodiment, the special glossy region A2 is printed with the metallic ink with reference to the dot recording rate table T2, so that dots having a larger size can be formed. When taking the purpose of the metallic ink into consideration, since gray scale display or image reproduction obtained by using the metallic ink with respect to the special glossy region A2 is not important, dot graininess or image quality degradation caused by such factors as banding do not have to be considered. Therefore, the amount of the metallic ink ejected per unit area is increased, so that the metallic dots can be formed in a wide range even if the number of scannings is small.

In one embodiment, the color part of the special glossy region A2 is subject to the halftone processing using the dot recording rate table T1 used for the dedicated color region A1. The color part of the special glossy region A2 can be subject to the halftone processing using a dot recording rate table (e.g., the dot recording rate table T2), in which dots having a larger size are defined, as compared with the dot recording rate table T1. Since the background color of the special glossy region A2 is the metallic color, the color ink is not visible, and the dot graininess or the image quality degradation caused by such factors as banding do not have to be considered. According to another aspect of the invention, for example, the special glossy region A2 can be printed with the metallic ink of small dots and the color ink of large dots. In this way, the color ink on the special glossy region A2 can be visible as compared with the metallic ink. Further, the halftone processing can be performed for the special glossy region A2 by using a table equal to the dot recording rate table used for the dedicated color region A1.

In one embodiment, as shown in FIG. 7, the local region having a size of 2×2 is filled in the sequence of left upper part, the left lower part, the right upper part and the right lower part. However, according to another embodiment, the local region having a size of 2×2 is filled in the sequence of the left upper part, the right lower part, the right upper part and the left lower part. Further, printing conditions described here are equal to the printing conditions described with reference to FIG. 7, which include the number of the metallic nozzles, the number of color nozzles, the number of overlappings, the nozzle pitch, the sheet transfer rate and the bi-direction printing.

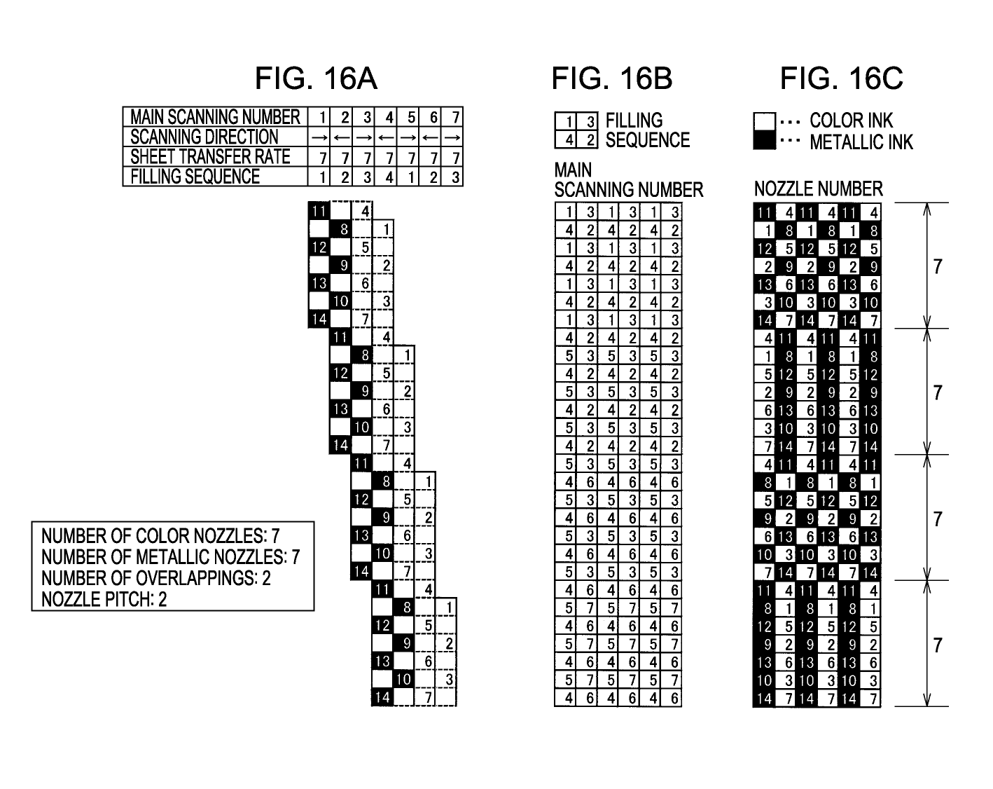

FIGS. 16A to 16C are views showing a print result in accordance with one embodiment. In a state in which the filling sequence is set as described above, when comparing FIG. 7B with FIG. 16B, dots are shifted by one dot in the transverse direction and formed in even rows. As a result, as shown in FIG. 16C, a pattern different from the pattern as shown in FIG. 7C is formed on the print medium. In an embodiment, the special dither mask D2 is formed based on the pattern as shown in FIG. 16C, so that the nozzles of the print head 241 can be classified into the precedent nozzle group and the subsequent nozzle group and then the printing can be performed.

According to the above described embodiments, the precedent nozzle group and the subsequent nozzle group include the same number of the nozzles, that is, 7, respectively. However, according to another embodiment, the number of the nozzles of the precedent nozzle group is set differently from the number of the nozzles of the subsequent nozzle group. More specifically, the precedent nozzle group includes four nozzles and the subsequent nozzle group includes 10 nozzles. Further, printing conditions described here are equal to the printing conditions described with reference with FIG. 7, which include the number of overlappings, the nozzle pitch, the sheet transfer rate and the bi-direction printing.

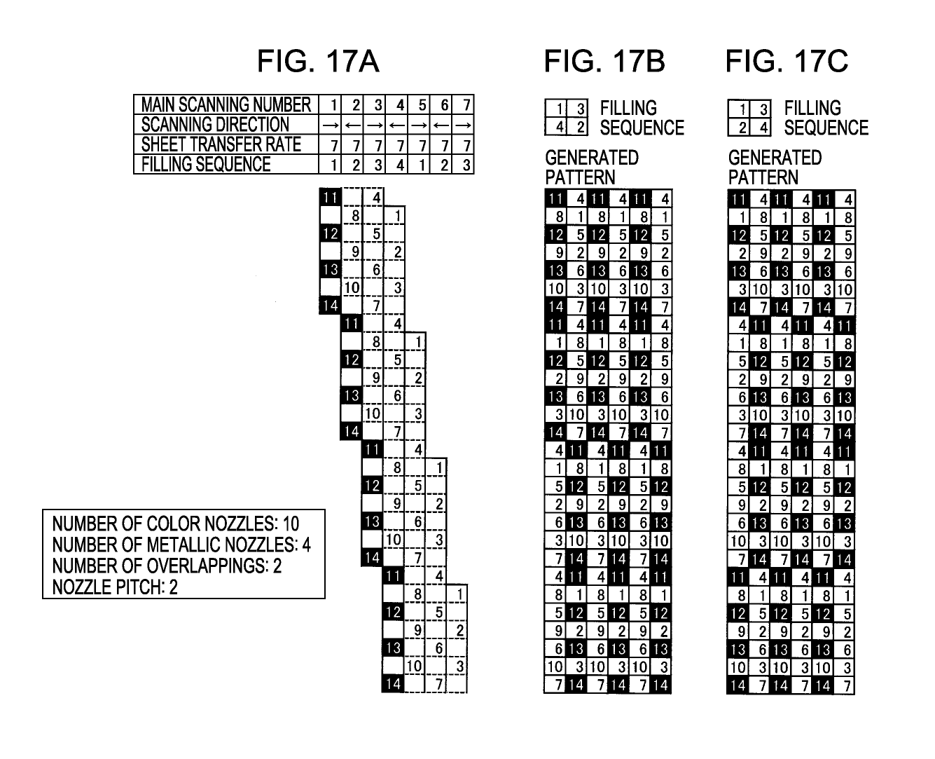

FIGS. 17A to 17C are views showing a print result according to one embodiment. FIG. 17A shows the nozzles shifted in the sub-scanning direction, which are included in the precedent nozzle group and the subsequent nozzle group. The number of the nozzles in the precedent nozzle group is different from the number of the nozzles in the subsequent nozzle group. FIGS. 17B and 17C show dot generation patterns depending on filling sequences different from each other. In an embodiment, the special dither mask D2 is formed based on the patterns as shown in FIGS. 17B and 17C, so that the number of the nozzles of the precedent nozzle group is set differently from the number of the nozzles of the subsequent nozzle group and then the printing can be performed, similarly to the previous embodiments. As is apparent from FIGS. 17A to 17C, according to one embodiment, the number of the main scannings of the print head 241 for filling a predetermined local region of the special glossy region A2 with the metallic ink is smaller than the number of the main scannings of the print head 241 for filling the predetermined local region with the color ink.

Further, according to one embodiment, the number of the nozzles, which eject metallic ink and are included in the precedent nozzle group, is smaller than the number of the nozzles included in the subsequent nozzle group. However, the invention is not limited thereto. That is, the number of the nozzles included in the precedent nozzle group may be larger than the number of the nozzles included in the subsequent nozzle group.

According to the previous embodiments, the filling sequence is set with respect to a local region having a size of 2×2. According to one embodiment, the filling sequence is set with respect to a local region having a size of 2×4.

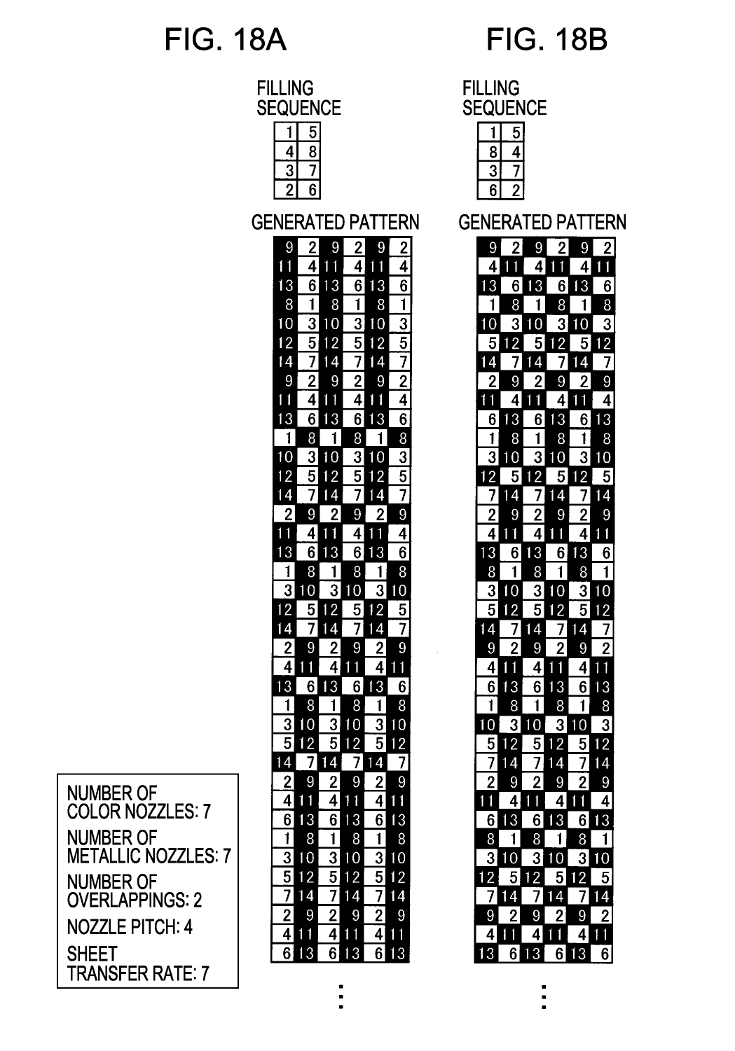

FIGS. 18A and 18B are views showing a part of a print result according to one embodiment. FIGS. 18A and 18B show the print result according to the different filling sequence. According to one embodiment, the bi-direction printing is performed under the printing conditions that the number of the nozzles included in the precedent nozzle group is 7, the number of the nozzles included in the subsequent nozzle group is 7, the number of overlappings is 2, the nozzle pitch is 4 and the sheet transfer rate is 7. As shown in FIGS. 18A and 18B, although the filling sequence is set with respect to a local region having the size of 2×4, a predetermined pattern is generated on the print medium. According to one embodiment, the special dither mask D2 is formed based on the patterns as shown in FIGS. 18A and 18B, so that the nozzles of the print head 241 can be classified into the precedent nozzle group and the subsequent nozzle group and then the printing can be performed.

According to one embodiment, the filling sequence is set with respect to a local region having a size of 2×4. According to another embodiment, the filling sequence is set with respect to a local region having a size of 4×2.

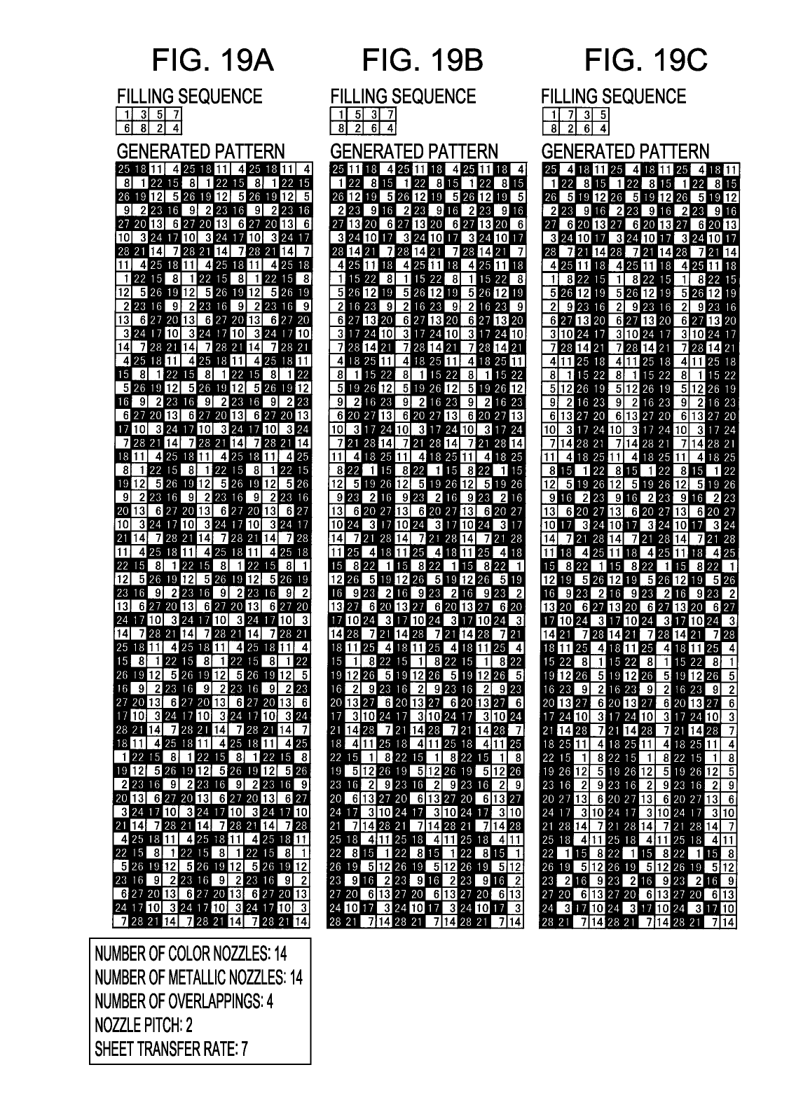

FIGS. 19A to 19C are views showing a print result according to one embodiment. FIGS. 19A to 19C show the print result according to the different filling sequence. According to one embodiment, the bi-direction printing is performed under the printing conditions that 28 nozzles are included in the nozzle array, the number of the nozzles included in the precedent nozzle group is 14, the number of the nozzles included in the subsequent nozzle group is 14, the number of overlappings is 4, the nozzle pitch is 2 and the sheet transfer rate is 7. As shown in FIGS. 19A to 19C, although the filling sequence is set with respect to a local region having the size of 4×2, a predetermined pattern is generated on the print medium. According to one embodiment, the special dither mask D2 is formed based on the patterns as shown in FIGS. 19A to 19C, so that the nozzles of the print head 241 can be classified into the precedent nozzle group and the subsequent nozzle group and then the printing can be performed.

Further, in order to improve the distribution of dots formed on the print medium, in one embodiment, it is preferred that the pattern formed on the print medium satisfies the following conditions: variation of the shape of the pattern is small in a band unit if possible; metallic dots and color dots are uniformly distributed; and dots are not continuously formed at adjacent pixel positions if possible. As a result of comparing the three types of patterns as shown in FIGS. 19A to 19C according to the above conditions, the pattern as shown in FIG. 19B has great variation, and the pattern as shown in FIG. 19C has longitudinal stripes caused by two continuous dots. Accordingly, the pattern as shown in FIG. 19A is the most advantageous in terms of image quality.

According to above-described embodiments, the nozzles are regularly shifted in the sub-scanning direction according to the regular sheet transfer rate. However, according to another embodiment, the sheet transfer rate is changed whenever the main scanning is performed.

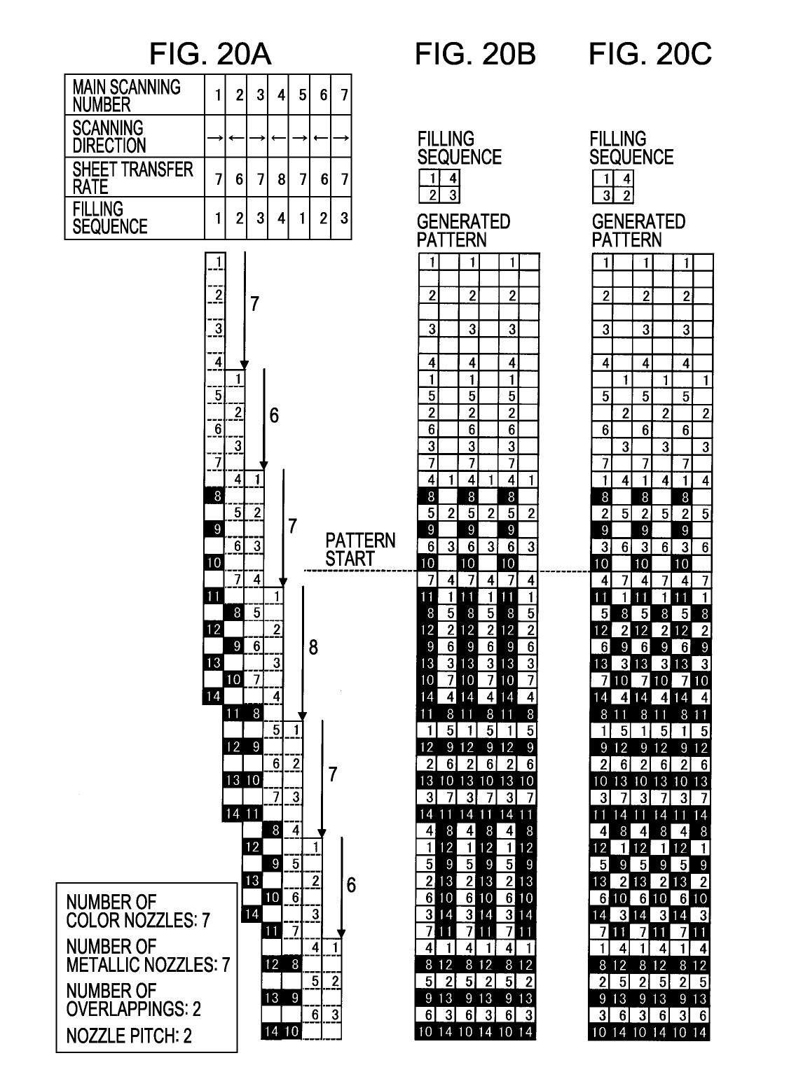

FIGS. 20A to 20C are views showing a print result according the embodiment. According to one embodiment, the bi-direction printing is performed under the printing conditions that 14 nozzles are included in the nozzle array, the number of the nozzles included in the precedent nozzle group is 7, the number of the nozzles included in the subsequent nozzle group is 7, the number of overlappings is 2, and the nozzle pitch is 2. FIG. 20A shows the nozzles irregularly shifted in the sub-scanning direction. As shown in FIG. 20A, according to one embodiment, the sheet transfer rate is changed in the sequence of 7, 6, 7 and 8 whenever the main scanning is performed. FIGS. 20B and 20C shows the print result according to such nozzle control, that is, FIGS. 20B and 20C shows the print result according to filling sequences different from each other. As shown in FIGS. 20A to 20C, although the sheet transfer rate is irregularly changed, a predetermined pattern is generated on the print medium. According to one embodiment, the special dither mask D2 is formed based on the patterns as shown in FIGS. 20B and 20C, so that the nozzles of the print head 241 can be classified into the precedent nozzle group and the subsequent nozzle group and then the printing can be performed.

According to the above-described embodiments, when the halftone processing is performed based on the ordered dither method, a special dither mask (i.e. the special dither mask D2) is used, the nozzle array of the print head 241 is classified into the precedent nozzle group and the subsequent nozzle group, and then the printing is performed. Further, when the halftone processing is performed based on an error diffusion method, the nozzle array of the print head can be classified into the precedent nozzle group and the subsequent nozzle group.

More specifically, if the gray scale data of each pixel has values in a range of 0 to 255, the halftone processing is performed based on the normal error diffusion method in the following sequence: 1) an error distributed from a pixel, for which the processing has been completed, is added to gray scale data of a target pixel; 2) the gray scale data after the error addition is compared with a predetermined threshold value (e.g., 127) so that binarization is performed; 3) an error is calculated between a value of 0 to 255 after the binarization and the gray scale data after the error addition; 4) the error is distributed to non-processed neighbor pixels at a predetermined rate; and 5) subsequent pixels are processed. According to one embodiment, the halftone processing is performed relative to the dedicated color region A1 in the above sequence.

In relation to the special glossy region A2, before the sequence 2, it is determined whether the number of a nozzle used for forming dots with respect to the target pixel is equal to or less than 7. More specifically, it is determined whether the nozzle belongs to the subsequent nozzle group, and then the threshold value is changed to a very high value (e.g., 1000), if the number of the nozzle used for forming dots in the target pixel is equal to or less than 7. Thus, the probability of forming dots with the nozzles 1 to 7 is significantly reduced. As a result, the metallic ink can be primarily printed through the precedent nozzle group including the nozzles 8 to 14.

According to the above-described embodiments, the printing system 10 including the computer 100 and the printer 200 performs the printing operation. However, the printer 200 can receive image data from a digital camera or various memory cards to perform the printing operation. That is, the CPU in the control circuit 260 of the printer 200 can perform the above printing process and the halftone processing, thereby performing the printing operation.

According to the above-described embodiments, a white printing paper is used as the print medium. Thus, the metallic ink is primarily printed and then the color ink is printed. However, in a case in which a transparent film is used as the print medium, and the film is observed from an opposite side of a printed surface, it is preferred that the color ink is primarily printed before the metallic ink is printed. In such a case, the special dither mask D2a for the color ink as shown in FIG. 8 is dedicated for the metallic ink, and the special dither mask D2b for the metallic ink as shown in FIG. 11 is dedicated for the color ink. In this way, the precedent nozzle group includes the nozzles that eject the color ink and the subsequent nozzle group includes the nozzles that eject the metallic ink.

According to the above-described embodiments, the metallic ink and the color ink are used for printing an image. However, white ink or transparent ink can be used instead of the metallic ink. In a case in which the transparent ink is used for the purpose of protection or gloss for a printed surface, it is necessary to print the transparent ink after printing the color ink. In such a case, threshold values are arranged on the special dither mask D2 such that the precedent nozzle group includes the nozzles that eject the color ink and the subsequent nozzle group includes the nozzles that eject the transparent ink. More specifically, the special dither mask D2a for the color ink as shown in FIG. 8 is dedicated for the transparent ink, and the special dither mask D2b for the metallic ink as shown in FIG. 11 is dedicated for the color ink.

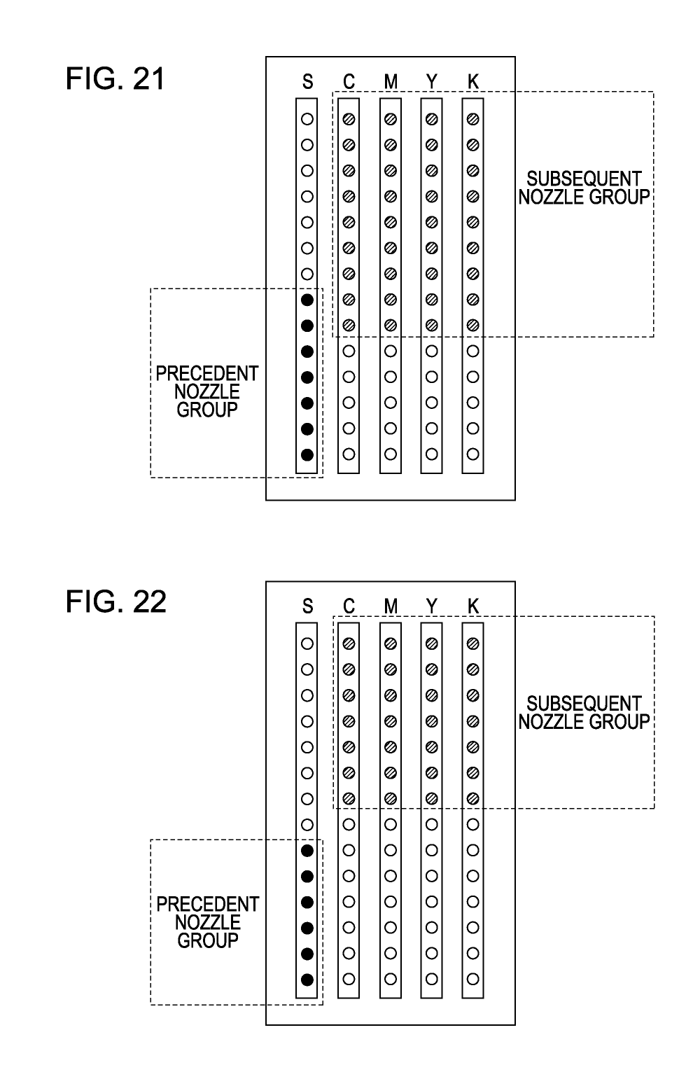

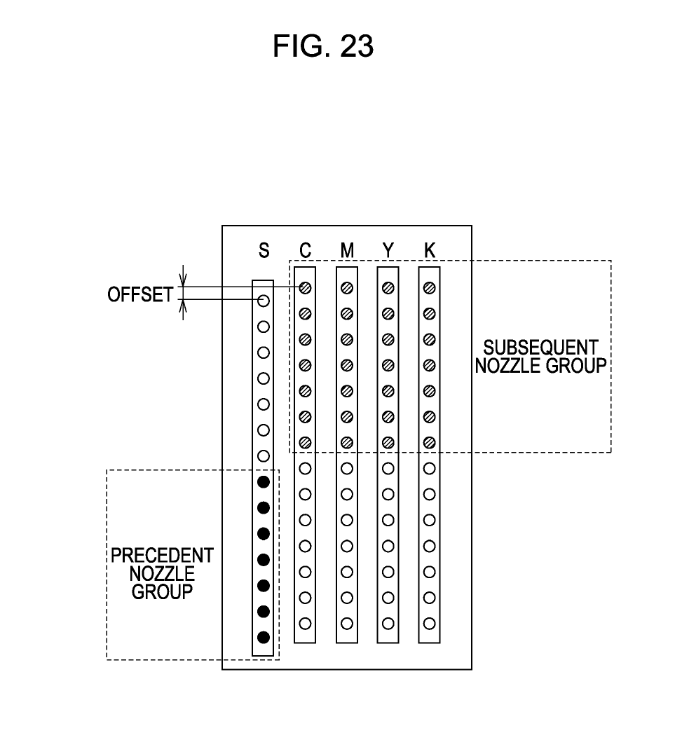

According to the above-described embodiments, as shown in FIG. 6B, the precedent nozzle group is located separately from the subsequent nozzle group in the sub-scanning direction. However, according to the present modification, as shown in FIG. 21, the precedent nozzle group may partially overlap the subsequent nozzle group in the sub-scanning direction. Further, as shown in FIG. 22, nozzles, which are not used, may be interposed between the precedent nozzle group and the subsequent nozzle group. Also, according to the above-described embodiments, the positions of the nozzles, which eject the metallic ink, in the sub-scanning direction coincide with the positions of the nozzles, which eject the color ink, in the sub-scanning direction. However, according to another embodiment, as shown in FIG. 23, the nozzles, which eject the metallic ink, may be offset from the nozzles, which eject the color ink, in the sub-scanning direction. Although the nozzles are arranged as shown in FIGS. 21 to 23, the special dither mask is generated according to the principle described in the first embodiment, so that printing can be performed by allocating the nozzles used for printing the special glossy region A2 to the precedent nozzle group and the subsequent nozzle group.

What is claimed is:

1. A printing apparatus that prints an image on a print medium using special glossy ink and color ink, the printing apparatus comprising:
a print head including a special glossy ink nozzle array having a plurality of special glossy ink nozzles for ejecting the special glossy ink and a color ink nozzle array having a plurality of color ink nozzles for ejecting the color ink, the special glossy ink nozzle array and the color ink nozzle array being disposed in a sub-scanning direction while facing each other;
a print unit that drives the print head in a main scanning direction crossing the sub-scanning direction and carries the print medium relative to the print head in the sub-scanning direction;
an image obtaining module that obtains image data having a dedicated color region, which is printed with the color ink, a special glossy region which is printed with the color ink and the special glossy ink; and
a print controller that prints the obtained image data on the print medium by controlling the print head and the print unit,
wherein when the special glossy region is printed, the print controller sets a number of the plurality of special glossy ink nozzles, which are substantially used in the special glossy ink nozzle array, differently from a number of the plurality of color ink nozzles.

2. The printing apparatus of claim 1, wherein in a case of printing the obtained image data on the dedicated color region, the print controller uses a relatively larger number of the plurality of color ink nozzles in comparison with a number of the plurality of color ink nozzles used when the special glossy region is printed.

3. The printing apparatus of claim 1, wherein when the special glossy region is printed, the print controller sets the number of the plurality of special glossy ink nozzles, which are substantially used in the special glossy ink nozzle array, to be smaller than the number of the plurality of color ink nozzles.

4. The printing apparatus of claim 1, wherein the group of the plurality of special glossy ink nozzles, which are substantially used in the special glossy ink nozzle array, partially overlap the group of the plurality of color ink nozzles, which are substantially used in the color ink nozzle array, in the sub-scanning direction.

5. The printing apparatus of claim 1, wherein the special glossy ink includes pigments having metallic luster.

6. A printing method using a printing apparatus that prints an image on a print medium using special glossy ink and color ink, the printing apparatus including:
a print head including a special glossy ink nozzle array having a plurality of special glossy ink nozzles for ejecting the special glossy ink and a color ink nozzle array having a plurality of color ink nozzles for ejecting the color ink, the special glossy ink nozzle array and the color ink nozzle array being disposed in a sub-scanning direction while facing each other, and
a print unit that drives the print head in a main scanning direction crossing the sub-scanning direction and carries the print medium in the sub-scanning direction relative to the print head;
wherein the printing method comprising:
obtaining image data having a dedicated color region, on which printing is performed using only the color ink, a special glossy region on which the printing is performed using the color ink and the special glossy ink; and
controlling the obtained image data to be printed on the print medium using a print controller that controls the print head and the print unit,
performing the printing by ejecting the special glossy ink and the color ink at timings different from each other after a group of the special glossy ink nozzles, which are substantially used in the special glossy ink nozzle array, is offset from a group of the color ink nozzles, which are substantially used in the color ink nozzle array, in the sub-scanning direction by a predetermined interval, in a case of printing the obtained image data on the special glossy region; and
performing the printing by setting a number of the plurality of special glossy ink nozzles, which are substantially used in the special glossy ink nozzle array, differently from a number of the plurality of color ink nozzles.

7. The printing method of claim 6, wherein in a case of printing the obtained image data on the dedicated color region, the print controller uses a relatively larger number of the plurality of color ink nozzles in comparison with a number of the plurality of color ink nozzles used when the special glossy region is printed.

8. The printing method of claim 6, wherein when the special glossy region is printed, the print controller sets the number of the plurality of special glossy ink nozzles, which are substantially used in the special glossy ink nozzle array, to be smaller than the number of the plurality of color ink nozzles.

9. The printing method of claim 6, wherein the group of the plurality of special glossy ink nozzles, which are substantially used in the special glossy ink nozzle array, partially overlap the group of the plurality of color ink nozzles, which are substantially used in the color ink nozzle array, in the sub-scanning direction.

10. The printing method of claim 6, wherein the special glossy ink includes pigments having metallic luster.

11. An application program on a computer system for controlling a printing apparatus that prints an image on a print medium using special glossy ink and color ink, the application program causing the computer system to execute:
obtaining image data having a dedicated color region, on which printing is performed using only the color ink, and a special glossy region on which the printing is performed using the color ink and the special glossy ink;
controlling the obtained image data to be printed on the print medium using a print head and a print unit, and
performing printing by setting a number of the plurality of special glossy ink nozzles, which are substantially used in the special glossy ink nozzle array, differently from a number of the plurality of color ink nozzles.

12. The application program of claim 11, wherein in a case of printing the obtained image data on the special glossy region, printing is performed by using a relatively large number of a plurality of color ink nozzles as compared with a plurality of special glossy ink nozzles substantially used when the special glossy region is printed, in a case of printing the obtained image data on the dedicated color region.

13. The application program of claim 11, wherein when the special glossy region is printed, the print controller sets the number of the plurality of special glossy ink nozzles, which are substantially used in the special glossy ink nozzle array, to be smaller than the number of the plurality of color ink nozzles.

14. The application program of claim 11, wherein the group of the plurality of special glossy ink nozzles, which are substantially used in the special glossy ink nozzle array, partially overlap the group of the plurality of color ink nozzles, which are substantially used in the color ink nozzle array, in the sub-scanning direction.

15. The application program of claim 11, wherein the special glossy ink includes pigments having metallic luster.

16. A printing apparatus that prints an image on a print medium using special glossy ink and color ink, the printing apparatus comprising:
a print head including a special glossy ink nozzle array having a plurality of special glossy ink nozzles for ejecting the special glossy ink and a color ink nozzle array having a plurality of color ink nozzles for ejecting the color ink, the special glossy ink nozzle array and the color ink nozzle array being disposed in a sub-scanning direction while facing each other;
a print unit that drives the print head in a main scanning direction crossing the sub-scanning direction and carries the print medium relative to the print head in the sub-scanning direction;
an image obtaining module that obtains image data having a dedicated color region, which is printed with the color ink, a special glossy region which is printed with the color ink and the special glossy ink; and
a print controller that prints the obtained image data on the print medium by controlling the print head and the print unit,
wherein, in a case of printing the obtained image data on the special glossy region, the print controller allows a group of the special glossy ink nozzles to be offset from a group of the color ink nozzles in the sub-scanning direction by a predetermined interval.

17. The printing apparatus of claim 16, wherein when the special glossy region is printed, the print controller sets a number of the plurality of special glossy ink nozzles, which are substantially used in the special glossy ink nozzle array, differently from a number of the plurality of color ink nozzles.

18. The printing apparatus of claim 16, wherein in a case of printing the obtained image data on the dedicated color region, the print controller uses a relatively larger number of the plurality of color ink nozzles in comparison with a number of the plurality of color ink nozzles used when the special glossy region is printed.

19. The printing apparatus of claim 16, wherein when the special glossy region is printed, the print controller sets the number of the plurality of special glossy ink nozzles, which are substantially used in the special glossy ink nozzle array, to be smaller than the number of the plurality of color ink nozzles.

20. The printing apparatus of claim 16, wherein the group of the plurality of special glossy ink nozzles, which are substantially used in the special glossy ink nozzle array, partially overlap the group of the plurality of color ink nozzles, which are substantially used in the color ink nozzle array, in the sub-scanning direction.

21. The printing apparatus of claim 16, wherein the special glossy ink includes pigments having metallic luster.
